(19) United States
(12) Patent Application Publication
(10) Pub. No.: US 2025/0017154 A1
(43) Pub. Date: Jan. 16, 2025

(54) PLANT GROWTH MEDIA

(71) Applicant: Lyrata Inc., Toronto (CA)

(72) Inventors: Patrick Diep, Mississauga (CA); Adnan Sharif, Toronto (CA); Jinming Liu, Mississauga (CA)

(21) Appl. No.: 18/712,999

(22) PCT Filed: Nov. 23, 2022
(86) PCT No.: PCT/CA2022/051723

§ 371 Date: May 23, 2024

Related U.S. Application Data
(60) Provisional application No. 63/282,787, filed on Nov. 24, 2021.

(51) Int. Cl. A01G 24/44; A01G 24/22

(52) U.S. Cl. CPC A01G 24/44; A01G 24/22

(57) ABSTRACT

A growing medium for plant organisms having a plurality of bodies forming a network of bodies. Each body in the plurality of bodies has a Shore D hardness value of at least 5. At least one body in the plurality of bodies has at least one pore for receiving a fluid.

### FIELD OF THE INVENTION

The present invention is directed to the field of hydroculture grow media. More particularly, the present invention provides a hydroculture grow media manufactured by additive manufacturing.

### INTRODUCTION

Hydroponics refers to the practice of growing plants without soil by providing a hydroculture grow media, also referred to as a substrate, and an aqueous nutrient solution directly to the plants' roots.

Current substrates are often made of organic materials, including mineral wool, clay pellets, and peat moss. These substrates are manufactured through energy-intensive processes. For example, mineral wool is made by melting minerals and rocks at 1600 degrees Celsius, which is then aerated and spun into a cotton candy-like fibrous material. Clay pellets are produced by pre-treating clay, which is then introduced into rotary kilns heated to 1150 degrees Celsius. Manufacturing hydroponic substrates at such high temperatures requires large amounts of energy.

The resultant substrates are substantially non-biodegradable and are generally not reusable. For example, after a single growth cycle, mineral wool is structurally degraded and its fibrous structure is filled with roots that cannot be easily removed. The fibers from the used mineral wool are non-biodegradable. Clay pellets may begin to structurally degrade after a second growth cycle, and the resultant particulate matter can cause damage to the hydroculture farm's systems, thereby limiting its reusability. Clay pellets are also non-biodegradable. Peat moss is not reusable as it decomposes after one growth cycle. Furthermore, the additives and binders used in the manufacture of peat moss are non-biodegradable. Peat moss is also not sustainably sourced since it is mined from sensitive ecosystems and plays an important role in the environment's carbon cycling.

### SUMMARY OF THE INVENTION

In accordance with one aspect of this disclosure, there is provided a growing medium for a plant organism comprising:
a plurality of bodies forming a network of bodies, each body in the plurality of bodies having a Shore D hardness value of at least 5,
wherein at least one body in the plurality of bodies has at least one pore for receiving a fluid.

In any embodiment, the at least one pore may extend from a first side of the at least one body to a second side of the at least one body such that liquid is passable from the first side to the second side.

In any embodiment, the at least one pore may be a recess in a first side of the at least one body.

In any embodiment, the network of bodies may have a network porosity in the range of about 20% to about 95%.

In any embodiment, the plurality of bodies may comprise a plurality of first bodies and a plurality of second bodies, wherein the plurality of first bodies and the plurality of second bodies are combinable to form the network of bodies.

In any embodiment, the plurality of first bodies and the plurality of second bodies may be combinable in a ratio such that the combination of the first bodies and the second bodies at the ratio forms the network having the at least one desired growth condition.

In any embodiment, a selectable parameter of each body in the plurality of first bodies may be different from the corresponding selectable parameter of each body in the plurality of second bodies and the selectable parameter may be at least one of structure, size, shape, material composition, void ratio, porosity, pore size, pore position, number of pores, hardness, compressibility, rigidity, bulk density, fluid retention, fluid percolation, pathogen resistance, permeability, surface chemistry, material bulk properties, or wettability.

In any embodiment, one or more bodies in the plurality of bodies may be modified to alter a surface property of the one or more bodies.

In any embodiment, the surface property modification may comprise at least one of amino acids, polypeptides, sugars, collagen, organic molecules, alkali earth metals, transition metals, polyatomics, or alkanes.

In any embodiment, the surface property modification may be at least one of a chemical or physical process.

In any embodiment, the surface property modification may be at least one of a surface air plasma treatment or alkali treatment.

In any embodiment, the plurality of bodies may be formed by at least one of additive manufacturing and injection molding.

In any embodiment, the at least one pore may be at least one of a macro intra-body pore and a micro intra-body pore.

In any embodiment, the network of bodies may have a plurality of inter-body pores.

In any embodiment, at least one body in the plurality of bodies may have a polyhedral shape.

In any embodiment, at least one body in the plurality of bodies may be round.

In any embodiment, each body in the plurality of bodies may have a melting temperature of at least 100° C.

In any embodiment, each body in the plurality of bodies may comprise a biodegradable material or a recyclable material.

In any embodiment, the biodegradable or recyclable material may be at least one of thermoplastic starch-based plastic (TPS), polyhydroxyalkanoates (PHA), polylactic acid (PLA), polybutylene succinate (PBS), or polycaprolactone (PCL).

In accordance with another aspect of this disclosure, there is provided a method of optimizing growth of a plant organism, the method comprising:
selecting a plant organism to be grown;
determining at least one desired growth condition of the plant organism;
selecting, based on the at least one desired growth condition, a plurality of bodies; and
combining the plurality of bodies to form a network for growing the plant organism, the network having the at least one desired growth condition.

In any embodiment, at least one body in the plurality of bodies may have at least one pore.

In any embodiment, the plurality of bodies may be a plurality of first bodies, and the method may further comprise selecting, based on the at least one desired growth condition, a plurality of second bodies.

In any embodiment, the method may further comprise combining the plurality of first bodies and plurality of second bodies together to form the network for receiving the plant organism.

In any embodiment, the first bodies and the second bodies may be selected based on a ratio of first bodies to second bodies such that the combination of first bodies and second bodies at the ratio forms the network having the at least one growth condition.

In any embodiment, the at least one desired growth condition may include water-to-air ratio, pathogen resistance, fluid retention, drainage of nutrient solution from roots of plant, porosity, structure, fluid percolation, bulk density, capillary action, texture, field capacity, matric potential, gravitational potential, osmotic potential, water capillarity, gas diffusivity, preferential flow, or submergence potential.

In any embodiment, the method may further comprise determining a plurality of desired growth conditions and selecting, based on the plurality of growth conditions, a plurality of bodies.

In any embodiment, the method may further comprise:
inserting the plant organism to be grown into the network of bodies;
adding at least one of a nutrient solution, gel, or water to the network of bodies; and
harvesting the plant from the network of bodies at the completion of the first growth cycle.

In any embodiment, the method may further comprise cleaning the network of bodies for reuse in at least a second growth cycle for the plant organism or for a second plant organism.

In any embodiment, cleaning the network of bodies may include achieving a sterility assurance level of less than 10-2.

In any embodiment, the method may further comprise, after determining the at least one desired growth condition:
designing the body having at least one parameter to achieve the desired growth condition, and
manufacturing a plurality of the bodies.

In any embodiment, the plurality of bodies may be manufactured by at least one of additive manufacturing and injection molding.

In any embodiment, the method may further comprise treating or coating at least one body in the plurality of bodies to modify a surface property of the body.

In any embodiment, the method may further comprise after determining the at least one desired growth condition:
designing the second body having at least one parameter to achieve the desired growth condition, and
manufacturing a plurality of the second bodies.

In any embodiment, the plurality of second bodies may be manufactured by at least one of additive manufacturing and injection molding.

In any embodiment, the method may further comprise treating or coating at least one second body in the plurality of second bodies to modify a surface property of the second body.

In any embodiment, the network of bodies may have a network porosity in the range of about 20% to about 95%.

In any embodiment, each body in the plurality of bodies may have a Shore D hardness of at least 5.

In accordance with another aspect of this disclosure, there is provided a kit for plant organism growth having at least one desired growth condition, the kit comprising:
a plurality of first bodies, at least one first body in the plurality of first bodies having at least one pore and each first body in the plurality of first bodies having a first parameter; and
a plurality of second bodies, at least one second body in the plurality of second bodies having at least one pore and each second body in the plurality of second bodies having a second parameter,
wherein the first parameter and the second parameter are at least one of structure, size, shape, material composition, void ratio, porosity, pore size, pore position, number of pores, hardness, compressibility, rigidity, fluid retention, fluid percolation, pathogen resistance, permeability, surface chemistry, material bulk properties, wettability, or bulk density,
the first parameter is different than the second parameter, and
a selection of the plurality of first bodies and a selection of the plurality of second bodies are combinable to form a network of bodies such that the network forms the at least one desired growth condition based on the first parameter and the second parameter.

In any embodiment, the kit may further comprise a plurality of third bodies, the third bodies being different than the plurality of first bodies and the plurality of second bodies.

In any embodiment, the kit may further comprise a plurality of fourth bodies, the fourth bodies being different than the plurality of first bodies, the plurality of second bodies, and the plurality of third bodies.

In any embodiment, the kit may further comprise a plurality of fifth bodies, the fifth bodies being different than the plurality of first bodies, the plurality of second bodies, the plurality of third bodies, and the plurality of fourth bodies.

In any embodiment, each body in the plurality of first bodies and the plurality of second bodies may have a Shore D hardness value of at least 5.

In any embodiment, the kit may further comprise at least one of a nutrient solution, water, or gel.

In any embodiment, the kit may further comprise at least one plant organism seed.

In any embodiment, the kit may further comprise instructions specifying a ratio of first bodies and second bodies such that the combination of the first bodies and the second bodies at the ratio forms the network having at least one desired growth condition.

In any embodiment, the kit may further comprise an additive that modifies the surface of at least one body in the plurality of first bodies or the plurality of second bodies.

In any embodiment, the additive may be at least one of a gel or surface modifier.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIGS. 1A-1B show an embodiment of a growth body at various perspectives;

FIGS. 2A-2B show another embodiment of a growth body at various perspectives;

FIGS. 3A-3H show a series of different growth body shapes;

FIGS. 4A-4C show a network of bodies forming a substrate with varying levels of intra-body porosity;

FIGS. 4D-4F show a network of bodies forming a substrate with varying levels of inter-body porosity;

FIGS. 5A-5D show a plant organism at varying stages of growth in a network of bodies;

FIG. 5E shows the bodies of FIG. 5A removed from a container;

FIG. 5F shows the bodies of FIG. 5A after they have been cleaned;

FIG. 6 is a flow chart of a method of optimizing the growth of a plant organism, and

FIG. 7 is an illustration of a growth process using a network of bodies in accordance with an embodiment described herein.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. None of the terms “coupled”, “connected”, “attached”, and “fastened” distinguish the manner in which two or more parts are joined together.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

As used herein and in the claims, two elements are said to be “parallel” where those elements are parallel and spaced apart, or where those elements are collinear.

### General Description of Hydroponics

Each plant organism has a basic set of requisite growing conditions including the presence and availability of water, nutrients and air, support for the plant organism's body weight and root structure, and a minimal pathogen presence. These growing conditions may be dictated by a plurality of substrate parameters which may include, but are not limited to, porosity, fluid retention, fluid percolation, capillary action, bulk density, drainage rate, and/or seepage rate. Hydroponic growth media offer more control over growing conditions than traditional outdoor growing techniques. This control over growing conditions may lead to a higher yield and quality of plant growth.

Conventional hydroponic substrates may include organic materials in an attempt to be sustainable. However, these organic hydroponic substrates are often not reusable and do not allow for optimized plant growth due to the lack of control of growth conditions. For example, the use of organic materials produces substrates that have a random, uncontrolled pore structure and thereby have random, uncontrolled growth conditions. Substrates of this type also may promote pathogen growth, structurally degrade within the first or second growth cycle, and structurally degrade during plant extraction (i.e., during harvest).

Accordingly, organic substrates may produce sub-optimal growing conditions resulting in reduced plant yield and quality. These growing conditions may include sub-optimal water-to-air ratio and a lack of pathogen resistance. A lack of pathogen resistance may result in pathogen growth on the substrate. Pathogens may shorten the service life of hydroponic systems, increase maintenance and labor costs, and may reduce the health of the plant organism being grown.

One example of an organic substrate is mineral wool. The porosity of mineral wool is formed by uncontrolled packing of fibers into blocks of various sizes, which correspondingly reduces and/or eliminates control over the water-to-air ratio growth condition. Mineral wool also has a slow water drainage rate which can create an ideal environment for the growth of pathogenic microorganisms.

Another example of an organic substrate is clay pellets. The porosity of clay pellets is uncontrollably produced and can be highly complex, resulting in a sub-optimal water-to-air ratio and poor water penetration into the clay pellets' bodies. Plants rely on nutrient solution to be held in the substrate bodies so that the plant's roots can access the nutrients. Accordingly, poor water penetration into the clay pellets' bodies may reduce the efficiency of plant growth and the health of the plant organism.

Another example of an organic substrate is peat moss. Peat moss is not amenable to being engineered for an optimal water-to-air ratio because the pores of peat moss cannot be easily controlled. Peat moss may also have poor drainage of nutrient solution from the root of the plant, which can cause oxygen starvation, rotting, and pathogen growth.

Accordingly, organic substrates are not sustainable solutions for hydroponic plant growth media because they provide poor growth conditions and cannot be easily reused. A sustainable substrate should result in reusable, biodegradable, and energy-efficient plant growth, which may also have the benefit of providing optimal growing conditions for each individual plant type such that the yield and/or quality of the plant organism is improved. A sustainable substrate may include materials that have temperature resistance, durability, and sterility, along with other material and mechanical properties such that the substrate is reusable, biodegradable, and energy-efficient to manufacture. Controlling the chemical, physical, and biological properties of the substrate may produce a substrate that is structurally robust enough to bear plant loads, resist pathogen growth, withstand plant extraction procedures, and/or withstand cleaning and maintenance procedures at the end of each growth cycle.

### Additively Manufactured Hydroponic Substrates

In accordance with one or more aspects described herein, a growth media may be produced by additive manufacturing. Additive manufacturing refers to the process of sequentially layering materials to create three-dimensional shapes. Additive manufacturing may include, but is not limited to, 3D printing, fused-deposition modelling (FDM), stereolithography (SLA), multi-jet fusion, and/or polyjet printing.

Additive manufacturing may enable the use of materials that qualify as sustainable, thereby allowing for a sustainable substrate to be formed. Specifically, additive manufacturing is an energy-efficient manufacturing process that may be used to produce structurally robust hydroponics substrate bodies using biodegradable, recyclable, and/or pathogen resistant materials. Further, by utilizing the precision and repeatability of additive manufacturing, a substrate designer may optimize the yield and quality of plant growth by designing a substrate with specific parameters required to optimize the growing conditions for a particular plant organism.

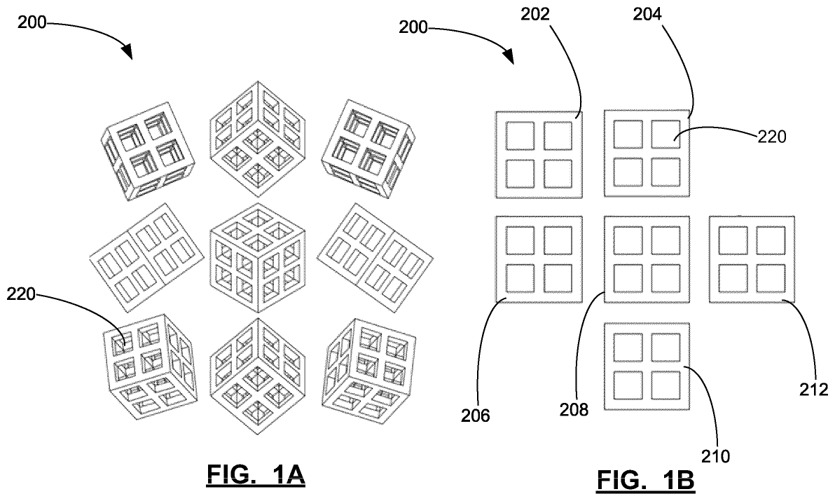

Referring to FIG. 1, an exemplary embodiment of a synthetic soil substrate body is shown generally as 200. The following is a general discussion of a substrate 100 formed of a plurality of bodies 200, which provides a basis for understanding several of the features that are discussed herein. As discussed subsequently, each of the features may be used individually or in any particular combination or sub-combination in this or in other embodiments disclosed herein.

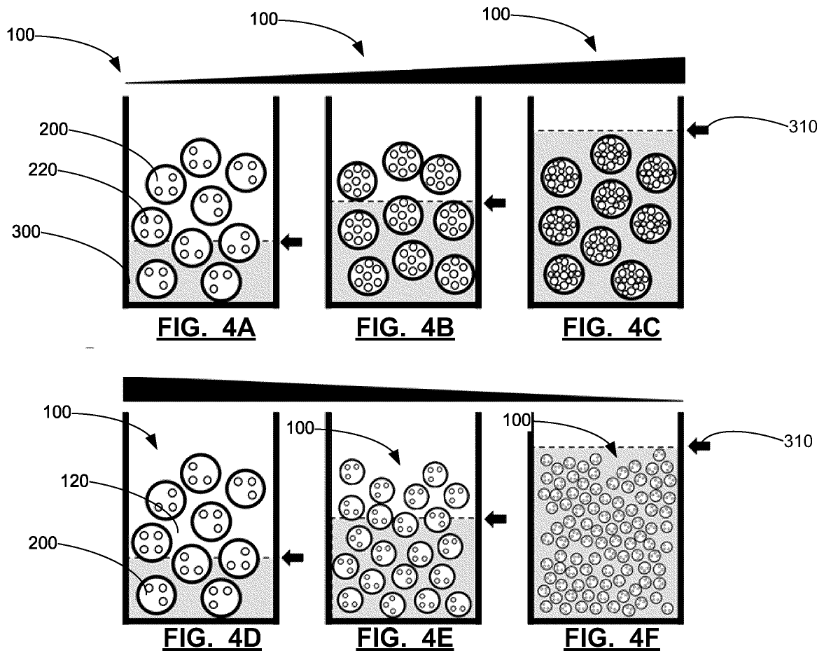

As shown in FIG. 4A, the substrate 100 is formed of a network of individual growth bodies 200. The substrate 100 may also be referred to as network 100. The network of bodies may be amenable to one or more cultivation methods such as, but not limited to, hydroponics, aquaponics, and/or aeroponics.

At least one body 200 in the plurality of bodies has at least one pore 220. The body 200 may have a plurality of pores 220. The pore 220 may be sized such that a fluid is receivable by the pore 220. The pore 220 may extend from a first side of the body 200 to a second side of the body 200 such that liquid is passable from the first side to the second side. In other words, the pore 220 may be a hole that extends through the body 200. In some embodiments, the pore 220 may be a recess or cavity. In other words, the pore 220 may not extend through the body 200, but may instead receive a fluid in the recess. In some embodiments, the at least one pore 220 includes a hole and a cavity. In some embodiments, the plurality of bodies may include at least one body 200 with at least one pore 220 and at least one body 200 having no pores.

The pore 220 may receive a nutrient solution conventionally used in hydroponics. Accordingly, submersion or partial submersion of each body 200 into the nutrient solution allows the body 200 to receive the nutrient solution in one or more pores 220. The received nutrient solution may then be used to provide nutrients to a plant organism being grown in the substrate 100. In some embodiments, the substrate 100 may be formed of a single body 200 with a plurality of pores 220. The nutrient solution may be aqueous and/or gel.

Various parameters of the substrate 100 may be optimized for plant growth. For example, these substrate parameters may include, but are not limited to, structure, size, shape, material composition, void ratio, porosity, pore size, pore position, number of pores, hardness, compressibility, rigidity, bulk density, fluid retention, permeability, pathogen resistance, fluid percolation, surface chemistry, and/or wettability. The ability to optimize these parameters in substrates produced by additive manufacturing may enable the growth of organisms that are conventionally difficult to grow in an optimal manner. Thus, a wider variety of plant organisms may be optimally cultivated through the synthetic soil substrates produced by additive manufacturing.

Producing an optimized, plant organism-specific substrate considers both the individual growth bodies 200 and the plurality of bodies 200 that interact to form the network 100. The individual bodies 200 may have a plurality of aspects that vary according to the desired growth conditions of the plant organism to be grown. For example, these aspects may include, but are not limited to shape, size, and pore structure. Additionally, the bodies 200 may be made of different material compositions, manufacturing methods, and plant organism cultivation methods that may vary depending on desired growth conditions of the particular plant organism to be grown. In other words, the bodies 200 may be designed to take into account one or more of the growth conditions listed previously. In addition to the optimization of each body 200, the network of bodies 100 may be designed such that the combination of the plurality of bodies 200 produces optimal growing conditions for the selected plant organism. Accordingly, additive manufacturing may provide a substrate 100 that is reusable, biodegradable, recyclable, customizable, repeatable, and/or pathogen resistant, while also being optimizable for any number of growth conditions.

The individual bodies 200 in the network of bodies 100 may be identical or different. For example, the bodies 200 in the network 100 may vary with one or more design parameters such that the network of bodies 100 form a non-uniform environment. A non-uniform environment may be desirable since it resembles the orientation of soil particles in arable land and provides an opportunity for more diverse rooting of the plant being grown.

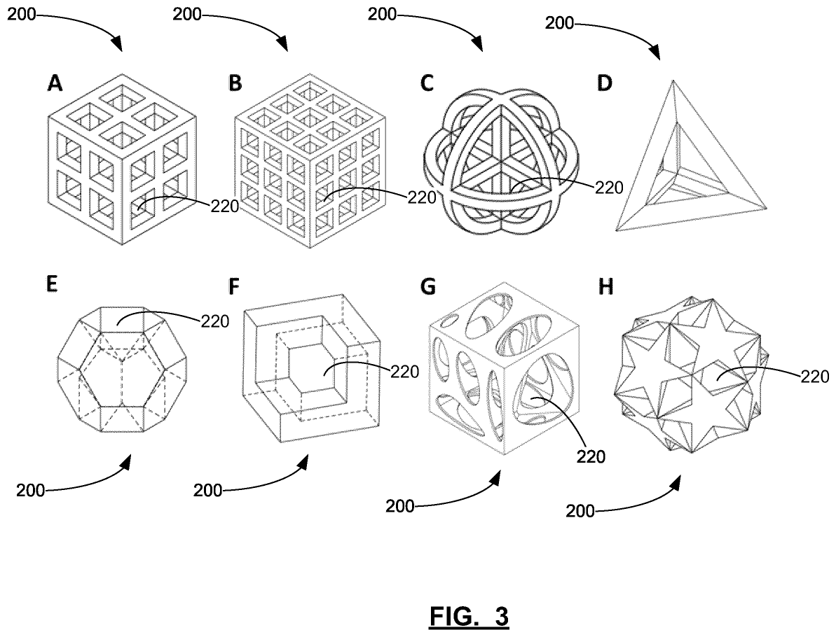

Through use of additive manufacturing, the individual body may be designed to be any shape. For example, each individual body 200 may be, but is not limited to, a polyhedral shape such as a cube, a cone, a cylinder, a triangular prism, a donut, or any combination thereof. The body 200 may be at least partially round or may have rounded edges. For example, the body 200 may be a sphere. FIG. 3A depicts a cubic design with large unit-cell pores 220 for increasing the aeration in the body 200. FIG. 3B depicts a cubic design with small unit-cell pores 220 for increased water holding capacity. FIG. 3C depicts a spherical design with uniform pores 220. FIG. 3D depicts a triangular prism body 200 having uniform pores 220. FIG. 3E depicts an irregular toroidal design with a single pore 220. FIG. 3F depicts a cubic toroidal design with a single pore 220. FIG. 3G depicts a cubic Voronoi design having five internal voids with sixteen pores 220 providing a fluid passageway to the internal voids. FIG. 3H depicts a complex polyhedral design with increased surface area formed by unconnected pores 220.

Bodies 200 having uniform pores 220 may improve the predictability of the performance of the body 200. For example, uniform pores 220 may result in a more homogenous water retention in the network 100. In other words, uniform pores 220 in the bodies 200 may improve the ability to control the porosity of the network 100 and bodies 200, thereby providing for increased control over water retention. Additionally, uniform pores 220 in the bodies 200 may simplify the manufacturing process. For example, when the bodies 200 are produced by injection molding, only one mold may be needed to produce a plurality of bodies 200, since the bodies 200 have uniform designs. Similarly, when designing the bodies 200 in CAD software for additive manufacturing, the design need only be constructed once, since the single design can be used to produce a plurality of bodies 200 with uniform pores 220.

Further, the bodies 200 may be designed to have different structures and textures including, but not limited to, smoothened edges, protrusions, cavities, and/or spikes. In other words, the bodies 200 may be any shape and/or texture capable of being produced by additive manufacturing.

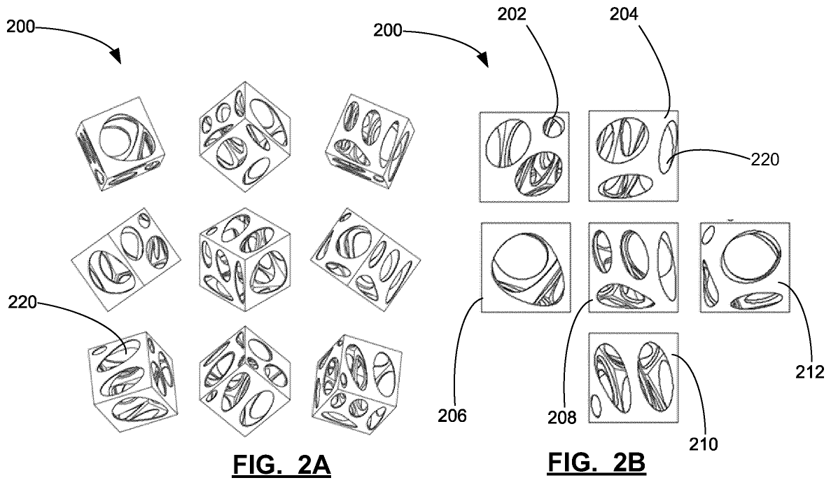

In some embodiments, the bodies 200 may be designed to have a regular and/or symmetric shape. As shown in FIGS. 1A-1B, the individual growth body 200 is generally cubic, having a first side 202, a second side 204, a third side 206, a fourth side 208, a fifth side 210, and a sixth side 212. The cubic body 200 may allow for increased aeration into the network 100. In some embodiments, the bodies 200 may be irregularly shaped. For example, as shown in FIGS. 2A-2B, the bodies 200 are cubic Voronoi shaped. A Voronoi shaped body 200 may allow for improved water retention due to the non-uniformity of the shape.

The size of each body 200 may vary depending on the desired plant growth conditions. The diameter of the individual body 200 may range from about 1-100 mm. For example, smaller plants such as lettuce may have bodies 200 in the range of 1-10 mm, vine crops such as tomatoes may have bodies 200 in the range of 5-50 mm, and larger plants, such as house plants and/or flowers, may have bodies in the range of about 10-100 mm. The bodies 200 may be sized larger than 100 mm to accommodate larger plant organisms. For example, a plant organism may be initially grown with smaller bodies 200, and as the plant organism grows, the plant organism may be repotted into a larger container having larger bodies 200. This process may be repeated as many times as needed. For example, if the plant organism is a tree, the bodies 200 may be very large to accommodate the larger roots.

It will be appreciated that the size of the bodies 200 may vary depending on the type of plant being grown and may be any size. Further, the bodies 200 may vary in size within the network 100. For example, a fast-growing plant may need a mixture of small and large bodies 200 to allow the roots to grow at an optimal pace with sufficient structural support for roots that increase in size.

The individual bodies 200 may be manufactured out of any material that is amenable to additive manufacturing and/or chemical modifications. For example, the substrate bodies may be manufactured out of non-organic matter including, but not limited to, thermoplastic starch-based plastics (TPS), polyhydroxyalkanoates (PHA), polylactic acid (PLA), polybutylene succinate (PBS), polyethylene terephthalate (PETG), and/or polycaprolactone (PCL) and combinations thereof. The substrate bodies 200 may be manufactured out of composite materials. For example, the material amenable to additive manufacturing may form the matrix of a composite having fibers and/or microfibers. The fiber component of the composite may include, but is not limited to, cellulose, glass, metal, carbon, or combinations thereof. For example, the metal may be copper. The material may be modifiable using chemicals to alter one or more surface properties of the body 200.

In some embodiments, the material used for the individual bodies 200 may be chosen based on glass transition temperature. The glass transition temperature may enable a material for use in additive manufacturing, such that the material may be extruded from a nozzle, and/or used in other forms of manufacturing such as injection molding. Additionally, the glass transition temperature of the manufacturing material may dictate the temperature of the printing bed in the additive manufacturing process. The glass transition temperature may be in the range of, for example, −75° C.-150° C. For example, the following materials and corresponding glass transition ranges may be used: Thermoplastic Start (TPS) (−75° C. to 10° C.), Polyhydroxyalkanoates (PHA) (2° C. to 8° C.), Polyactic Acid (PLA) (50° C.-80° C.), Polybutylene Succinate (PBS) (−28.5° C.), Polycaprolactone (PCL) (−60° C.), and combinations thereof.

In some embodiments, the material used for the individual bodies 200 may be chosen based on melting temperature. The melting temperature may enable a material for use in additive manufacturing, such that the material may be extruded from a nozzle, and/or used in other forms of manufacturing such as injection molding. For example, the melting temperature of the material used for the individual bodies may be at least 100° C., and optionally may be in the range of about 100° C. to about 300° C.

The material composition of bodies 200 may also be chosen based on additional chemical, biological, and/or physical properties including, but not limited to, biodegradability, solubility in aqueous solution, hydrophobicity, cost, biocompatibility (e.g., materials that do not produce harmful environmental by-products), hygroscopicity and/or sterility assurance level (SAL). For example, the chemical, physical, and/or biological properties of the individual bodies 200 may be designed to control a single aspect or a plurality of aspects that produce one or more desired growth conditions. These aspects may include, but are not limited to, fluid percolation, fluid retention, capillary action, hydrophobicity, cation exchange capacity, color, porosity, bulk density, texture, pH, organic matter content, electrical conductivity, structure, shape, size, chemical reactivity in aqueous solution, sterility assurance level. The individual bodies 200 may be made of materials that are substantially hydrophobic such that they experience minimal structural degradation in aqueous solution. Additionally, their bulk density may remain relatively consistent through prolonged aqueous solution exposure.

Design software may be used to control the additive manufacturing of the bodies 200, thereby controlling one or more growth conditions. The physical structure of the individual bodies may be rendered using computer-aided design (CAD) tools including, but not limited to, MATLAB®, Autodesk® Inventor™, Autodesk Fusion 360®, SolidWorks®, and Rhino®. The rendering may include designing the shape, size, texture, and/or intra-body pore structure of each individual body 200, or any other physical, biological, and/or chemical aspect. For example, the intra-body pores within each body 200 may be designed to retain fluid at desired rates and ratios to accommodate different plant organisms' needs and to generate optimal growth conditions for the different plant organisms. The use of additive manufacturing to control parameters such as the intra-body pores of the bodies 200 may allow for more variation than traditional growth media. For example, traditional growth media may have pores that resemble a coral, sponge, lattice-like, mesh-like and or braid-like structure. While these intra-pore shapes are possible with additive manufacturing, additive manufacturing provides further control to allow the intra-pores to be any shape and/or size, allowing for improved plant organism growth through the design optimization process.

As shown in FIGS. 1-4C, each body 200 has intra-body pores 220. Intra-body pores are pores that are within the individual body 200, rather than between bodies 200 in the network 100. Spaces between bodies 200 in the network 100 may be referred to as inter-body pores 120, as exemplified in FIGS. 4D-4F. The intra-body pores 220 may be designed with varying size and/or orientation to control growth conditions including, but not limited to, the fluid percolation, fluid retention, and water capillarity. The intra-body structure may include micro-intra-body pores, macro-intra-body pores, or a combination thereof. Micro-intra-body pores are pores that are smaller than 0.08 mm in diameter with a total void fraction less than 0.05 when present alone in the individual body 200. Micro-pores may be formed by chemically or physically treating the body 200. Macro-intra-body pores are pores that are larger than 0.08 mm in diameter with a total void fraction less than 0.50 when present alone in the individual body 200. Macro-pores may be formed by controlling the additive manufacturing process, chemically treating, and/or physically treating the body 200.

The void fraction of each body 200 may be controlled during the design process. Void fraction refers to the ratio of void space in a total volume of the individual body 200. In other words, void fraction is the total void volume in the individual body 200 divided by the total volume of the body 200. The void fraction may be controlled by altering the number of micro-intra-body pores and/or macro-intra body pores. For example, a void fraction using macro-intra-body pores may be 0.50, which resembles traditional hydroponic substrates such as peat and clay. Any structure that has a void fraction of more than 0.50 may be considered to have intra-body pores. The void ratio of the body 200 may vary depending on the desired growth conditions of the plant to be grown. For example, substrates with a large void ratio may be a shell-like structure with many and/or large intra-body pores 220, capable of holding water within the shell-like structure.

The amount and orientation of macropores, micropores, and void spaces in the body 200 may be engineered and/or selected on an organism-specific basis to control properties that are important to hydroculture cultivation. For example, the pore structure of the body 200 may allow for control over properties including, but not limited to, water-to-air ratio, pathogen resistance, drainage, fluid retention, fluid percolation, bulk density, capillary action, porosity, texture, structure, field capacity, matric potential, gravitational potential, submergence potential, gas diffusivity, preferential flow, and/or osmotic potential.

A higher number of intra-body pores 220 may be associated with higher fluid retention rates, and a smaller number of intra-body pores may be associated with lower fluid retention rates. As shown in FIGS. 4A-4C, intra-pore density in the bodies 200 influences the water capillary effect. Referring to FIG. 4A, the bodies 200 have few intra-body pores 220, resulting in a low water level 310. As shown in FIG. 4B, the bodies 200 have a higher number of intra-body pores 220 than the bodies 200 in FIG. 4A, resulting in a higher water level 310. Similarly, as shown in FIG. 4C, the bodies 200 have a higher number of intra-body pores 220 than the bodies in FIG. 4B, resulting in a higher water level 310. In other words, increasing the intra-body pore volume may enable more water to be trapped inside the bodies 200 for the plant organism roots to access.

Varying the amounts of macro-intra-body pores and micro-intra-body pores may be used to form different combinations and orientations of the substrate 100 to modify the fluid retention and percolation rate of the substrate 100. For example, micro-intra-body pores may be associated with slower fluid percolation rates because water is held against the force of gravity. In contrast, macro-intra-body pores may be associated with faster fluid percolation rates because water cannot be held against the force of gravity.

Controlling the fluid percolation rate of the substrate 100 may ensure sufficient root zone fluid drainage is achieved. Sufficient root zone fluid drainage may prevent pathogen accumulation at the root zone and base of the organism's stem during cultivation and harvesting. In some embodiments, the substrate 100 may include one or more treatments and/or coatings that affect the surface of the substrate 100. For example, the treatment and/or coating may modify one or more surface properties of the substrate 100. A treatment may be referred to as a process that physically or chemically alters a surface property of the substrate 100. A coating may refer to a process of applying a new layer onto the surface to alter the effective surface properties of the substrate 100. The coating may vary with the structure of the body 200. For example, larger bodies with larger pores may need a different type of coating to assist with retaining the coating on and/or within the body 200.

In some embodiments, the treatment and/or coating may modify one or more parameters of the bodies 200. The surface modification may include chemical and/or physical processes by treating and/or coating one or more bodies 200 in the network 100. For example, the treatment and/or coating may facilitate, including, but not limited to, ion exchange, hydrophobicity, hydrophilicity, plant hormones, plant stimulants, antimicrobials, wettability, and/or antifungals. The treatment and/or coating may reduce pathogen growth. These treatments and/or coatings may be food-safe coatings. For example, N-halamine with dopamine functional groups may be used to treat and/or coat the surface of the individual bodies 200 to prevent the growth of pathogenic bacterial and algal biofilms prominent in spinach hydroculture cultivation.

The treatment and/or coating may be made of any composition to facilitate one or more of the above functions. For example, the treatment may include, but is not limited to, surface air plasma treatment, alkali treatment, and/or sanding. The coating may include, but is not limited to, for example, amino acids, polypeptides, sugars, collagen, organic molecules, alkali earth metals, transition metals, polyatomics, mineral nutrients, and/or alkanes. The mineral nutrients may include, but are not limited to, Zn, Ca, Mg, and/or Fe. The polyatomics may include, but are not limited to, nitrates, sulfates, carbonates, and/or phosphates. The treatment and/or coating may be applied to the surface of the bodies 200 by any means. For example, the treatment and/or coating may be applied by, but is not limited to, alkaline surface hydrolysis, atom transfer polymerization, plasma treatment, and/or other chemical treatments.

In some embodiments, the coating may be a semi-solid, such as a gel. The gel coating may be used to coat some or all of the bodies 200 in the network 100. The gel may be used, for example, to improve the fluid and/or nutrient retention of the bodies 200. The gel may be used throughout the entire life cycle of the plant organism or a portion of the life cycle of the plant organism. For example, the gel may be used during the germination phase of the plant organism to assist with additional fluid retention. The amount of gel may vary with the plant organism and the stage of growth of each plant organism.

Pathogen growth on the substrate 100 may also be controlled by use of materials that are relatively or completely inert. In other words, materials for use in the substrate 100 may be chosen based on their pH, conductivity, and/or salinity. For example, the material used to manufacture the bodies 200 may be RoHS compliant anti-microbial PLA filament.

The individual bodies 200 may be designed based on bulk density. The bulk density of the individual bodies may be in the range of about 0.1 to about 4 g/cm³, optionally about 0.1 to about 3 gm/cm³. For example, the bodies 200 may have a bulk density such that the individual bodies sink and do not float when submerged in water, gel, and/or nutrient solution. Designing the bodies 200 so that they sink may improve the structural support of root growth on the substrate 100. Similarly, the mass density of the bodies 200 may be controlled to vary the water retention and/or structural supportability of the substrate 100.

The material composition of the individual bodies 200 may be chosen based on their robustness and reusability. For example, the individual bodies 200 maintain their structure and may not degrade after a single-use growth cycle, or upon the application of physical pressure during a growth cycle, plant extraction, and/or cleaning procedures.

The material composition of the individual bodies 200 may be chosen based on hardness. Hardness may contribute to the reusability and therefore sustainability of the substrate 100. Hardness is the measure of a material's resistance to localized plastic deformation (e.g., a small dent or scratch). Harder polymer materials are often more resistant to the pressures and forces applied throughout the course of multiple hydroponic re-uses, such as those during cleaning protocols that might mechanically damage the individual body surfaces. The bodies 200 may have a Shore D Hardness of at least 5. In some embodiments, the individual bodies may have a Shore D Hardness of about 5-100, optionally about 30-100, optionally about 40-90, or optionally about 45-85. For example, the following materials may be used for the bodies 200, with an approximate Shore D Hardness value range provided for each in parentheses: silicone-based filaments (0-30), high-impact polystyrene (HIPS) (60-75), Polyethylene terephthalate glycol (PETG) (60-75), Polyethylene terephthalate (PET), (85-95), Polypropylene (PP) (70-80), Polycarbonate (PC) (80-95), Acrylonitrile Butadiene Styrene (ABS) (50-100), and/or Wood-PLA (50-80). It will be appreciated that any material capable of being additively manufactured may be used.

Hardness may improve one or more growth parameters, such as fluid retention, in the network 100 of bodies 200 throughout the growth of the plant organism. For example, as a plant organism grows, the mass of the plant organism increases over time. This increase in mass increases the pressure that the plant organism applies to the network 100. If the bodies 200 are too soft (e.g., compressible), the porosity of the bodies 200 and the network 100 may decrease, reducing the fluid retention over time. This reduction in fluid retention may harm the growth of the plant organism or reduce the growth efficiency. If the bodies 200 are hard enough to withstand the weight of the plant organism as it grows, the fluid retention may be retained over time, improving the growth efficiency and health of the plant organism. For example, bodies 200 with a Shore D value of at least 5 may withstand the weight of plant organisms as they grow. Bodies 200 with a Shore D value of less than 5 may be compressed, thereby reducing the fluid retention and efficiency.

In some embodiments, material for the substrate 100 may be chosen based on other structural material parameters including, but not limited to, rigidity, ductility, compressibility, shear strength, chemical robustness, and/or tensile strength of the material. For example, the chemical robustness of the substrate 100 may allow the bodies 200 to be chemically cleaned repeatedly while resisting degradation.

The individual bodies 200 may be made of materials that enable easy separation of the bodies 200 from the root structure of a plant organism after the growing process has begun. Additionally, once separated from the roots of the plant, the substrate 100 may be cleanable. For example, the individual bodies may be cleaned and sterilized for reuse using products including, but not limited to, water, boiling water, 20%-70% acetic acid, ozone gas, 70% ethanol, 30% KOH, or H2O2. Accordingly, materials may be selected that enable the substrate 100 to be cleaned without structural degradation. The individual bodies may be cleaned to a sterility assurance level of that of similar medical and/or food grade devices. For example, the SAL may be less than about 10⁻², optionally less than about 10⁻³.r

Suitable materials for use in the bodies 200 may also be amenable to one or more manufacturing methods including, but not limited to, additive manufacturing, injection molding, extrusion, and/or casting. For example, the substrate 100 may be formed by fused deposition modeling to accurately and repeatably create individual bodies 200 that have complex internal structure with low volumes. In some embodiments, the bodies 200 may be formed through injection or microinjection molding. Injection molding may allow a plurality of bodies 200 to be manufactured simultaneously, thereby improving the speed of manufacturing. Additionally, the use of a mold in injection molding may improve the repeatability of manufacturing identical bodies 200, thereby improving the uniformity of the network 100.

### Network

As noted previously, a plurality of individual bodies 200 may be combined into a network of bodies 100 forming the substrate 100 for use in hydroponically growing one or more plant organisms. The inclusion of a plurality of bodies 200 may offer improved support to the root systems of plant organisms while also increasing the ability to customize the substrate 100. For example, different types of bodies 200 may selected based on physical, biological, and/or chemical properties such that the network 100 may be controlled for any number of growth conditions to optimally grow a plant organism.

The network 100 may be contained in a defined area, such as by a container 300. The container 300 may be any object capable of containing one or more bodies 200. For example, the container 300 may be, but is not limited to, a growing cup, a growing netpot, a growing tray, and/or a bucket. Altering the physical, biological, and/or chemical parameters of the individual bodies 200 in the network 100 contained within a given volume (i.e., container 300) may allow for improved control over water capillary effect and thereby physical properties including, but not limited to, fluid percolation and fluid retention. The addition of intra-body pores 220 into these bodies 200 as described previously may allow for further calibration of the water level. This control may broaden the potential application of the substrate 100 to be used in, for example, the commercial hydroculture cultivation of “hard-to-hydroponically-cultivate” crops such as root vegetables.

The individual bodies 200 of the network 100 may be designed with dissimilar, similar, or the same parameters including, but not limited to, structure, size, shape, texture, porosity, and/or material composition. In other words, the network 100 may be customizable through the choice of each individual body 200 in the plurality of bodies 200 that makes up the network 100. For example, the network 100 may have bodies 200 of different shapes, sizes, and/or material compositions such that one or more growth conditions may be controlled to optimize the growth of the plant. As noted previously, the network 100 may form a non-uniform environment resembling the orientation of soil particles found in arable land, thereby improving the ability to optimize the growth of the plant.

For example, the network of bodies 100 may resemble loose particles of soil. This configuration may allow the plant organism to form a healthy and extensive root structure within the network of bodies 100. It may also enable easier separation of the root structure from the plurality of bodies 200 when harvesting the plant organism at the completion of a growth cycle. Loose particles of known structure and porosities may allow for further fine-tuning of the growth conditions. As described previously, various parameters of each growth body 200 may be designed to control the growth conditions. The combination of a plurality of individual bodies 200 to form the network 100 allows for further control over the growth conditions of the network 100, since each body 200 provides an opportunity to adapt the overall network structure. For example, as seen in FIGS. 4D-4F, the inter-body pores 120 located between the individual bodies 200 in the network of bodies 100 generate an environment to support the root systems and control water capillarity, among other growth conditions. In other words, the spacing between each body 200 may be controlled by selecting particular shapes and sizes of the bodies 200 such that the inter-body pores 120 are varied to achieve the desired structure for a particular plant to be grown. For example, different shapes and sizes of bodies 200 may vary the inter-body pores 120. The inter-body pores 120 may be generally consistent, or may vary depending on the selected bodies 200 forming the network 100. In some embodiments, the network 100 may only have inter-body pores 120. In other words, the bodies 200 that make up the network 100 may not have intra-body pores 220 such that the porosity of the network 100 is formed by inter-body pores 120.

Particle size (i.e., size of bodies 200) in a given volume may dictate inter-body pores 120 and thereby may determine the water capillary effect. FIGS. 4A-4F indicate a water level 310 in container 300 based on the intra-body pores 220 and the inter-body pores 120. For example, as shown in FIG. 4D, bodies 200 of larger size in the container 300 may generate larger inter-body pores 120, resulting in a lower water capillary effect. As shown in FIG. 4E, bodies 200 of intermediate size in the container 300 may generate intermediate inter-body pores 120, resulting in an intermediate water capillary effect. As shown in FIG. 4F, bodies 200 of smaller size in the container 300 may generate small inter-body pores 120, resulting in a higher water capillary effect. In other words, decreasing the inter-body pore volume by using bodies 200 that are smaller in size, with proportionally sized pores 120, may provide more surface area for the water to adhere to, thereby keeping water inside the network 100 for the plant organism roots to access.

Similarly, the shape and/or texture of the individual bodies 200 in the network 100 may impact the growth conditions. For example, rounded bodies and/or bodies with smoothened surfaces may ensure higher fluid percolation because smoothened surfaces present less frictional forces, which keep water against the force of gravity.

Together, the bodies 200 in the network 100 form the substrate 100 having an overall network porosity. The network porosity of the network 100 is a result of the combination of inter-body pores 120 and intra-body pores 220. In other words, the network porosity is calculated by adding the total intra-body pore volume to the inter-body pore volume and dividing the sum by the total volume of the network 100. The network porosity may be varied to be any value depending on the desired growth conditions of the plant organism to be grown. For example, the network porosity may be in the range of about 20% to about 95%. It will be appreciated that the network porosity may vary from plant to plant. For example, the network porosity may be about 86-96% for basil, about 67-88% for lettuce, about 58-74% for spinach, or about 57-97% for tomatoes. In some embodiments, the network porosity may vary with the size and/or shape of the bodies 200. For example, a network 100 of spherical bodies 200 may have a maximum network porosity of 70%.

The desired growth conditions for a particular plant organism may be determined theoretically or empirically and may subsequently be used to design the substrate 100. For example, a crop coefficient (K_{c}) may be used to determine the water demand for a particular plant organism. Since the crop coefficient is a known parameter for a specific plant organism, the physical, biological, and/or chemical aspects of the bodies 200 may be designed such that the water demand for the plant to be grown is met by the substrate 100. Table 1 below provides a summary of various examples of plant organisms with their relative crop coefficients and handling needs:

TABLE 1
Design Methodology for Substrate According to Water Demands

| | | MEDIUM WATER | |
|---|---|---|---|
| | LOW WATER | DEMAND | HIGH WATER |
| | DEMAND | (2.78 < Total K_{c} < | DEMAND |
| | (Total K_{c} < 2.78*) | 3.12*) | (Total K_{c} > 3.12*) |
| Crop Examples per | Barley, oat, wheat, | Cucumber, lettuce, | Carrot, potato, |
| Category | rye, oil crops, bean, | spinach, pepper, | tomato, onion, pea, |
| | some herbs, berries | radish, basil | sugar beet, alfalfa |
| Soil Porosity | <60% | 60-90% | >90% |
| (Vₚ/Vₜ) | | | |
| Water Retention | <50% | 50-120% | >120% |
| (g_{H2O}/gₛₒᵢₗ) | | | |
| Unique Cleaning/ | Pathogen | Mechanical | Heat Resistance |
| Handling Needs, | Resistance | Strength | (for e.g., steam |
| Examples | | | sterilization) |
| Pellet Modifications | Pathogen | Mechanical | High Water |
| for Unique Needs, | Resistance: | Strength: | Retention: |
| Examples | Hydrophobic | Increase Vₛ | Hydrophilic coating, |
| | coating, organic/ | (volume of solid | increase porosity |
| | natural | material, PLA+/ | Heat Resistance: |
| | antimicrobial | polycarbonate | PLA+, PETG, PP |
| | coating | filament | filament |

*Values for KC (crop coefficient) are obtained from a UN FAO documentation. The values reported here are intended to provide an example of how to categorize the water demand of various crops. An alternative that may be used to categorize crops into the three divisions is crop water need (mm Water/growing period).

Where Vₚ=volume of total pore space contained in the network volume=intra-pore volume+inter-pore volume
Vₛ=total volume of solid material in the network
Vₜ=total network volume

Accordingly, the network 100 may be designed based on the water demand for each plant organism. For example, for plants in the first column of Table 1 having low water demand, bodies 200 with relatively large intra-body pores 220 may be used, such as the body 200 shown in FIG. 3F. For plants in the second column of Table 1 having a medium water demand, bodies 200 with medium intra-body pores 220 may be used, such as the body 200 shown in FIG. 3A. For plants in the third column of Table 1 having a high water demand, bodies 200 with relatively small intra-body pores 220 may be used, such as the body 200 shown in FIG. 3B. It will be appreciated that any combination of the same or different bodies 200 may be used to achieve the desired water demand for the particular plant to be grown. For example, instead of using the body 200 shown in FIG. 3A, a combination of bodies 200 from FIGS. 3F and 3B may be used to form the network 100 that may support a plant organism requiring a medium water demand.

The crop coefficient K_{c} is used as an example of a theoretical value that may be used to determine the growth conditions for a particular plant to be grown. Any theoretically or empirically determined parameters may be used to provide details on the water demand for a particular plant organism, which, in turn, may be used to design the bodies 200 and the network 100.

In some embodiments, the growth conditions for each plant organism may be determined empirically. For example, a designer may begin by collecting physical, chemical, and/or biological data for the plant to be grown (e.g., lettuce, basil, spinach), including, but not limited to the ideal rootzone fluid retention, ideal root-zone fluid percolation, and pathogen susceptibility.

The bodies 200 in substrate 100 may be subsequently designed and formed on the premise of this empirically determined data. Using design tools such as CAD, a designer may build a three-dimensional shape that forms the body 200. In this example, the ideal individual body 200 may be, for example, between 10-20 mm in diameter and may have, for example, at least 4 macro-intra-body pores and at least 20 micro-intra-body pores. The macro-intra-body pores may occupy the surface of the substrate 100, while the micro-intra-body pores may occupy the internal portions of the substrate 100. As described previously, macro-intra-body pores on the external surface of the body 200 may ensure sufficient fluids can enter the body 200 and micro-intra-body pores inside the body 200 may ensure that fluid is properly retained within the body 200 to provide the nutrient solution to the root systems.

Fluid retention may be controlled in various ways, based on empirical and/or theoretical data. For example, the structural parameters of the bodies 200 may be controlled to modify the resultant fluid retention value for a given plant organism. This modification may allow a plant organism to have approximately optimal fluid retention over the course of its growth period. For example, the pore size, material composition, porosity, size, shape, and/or structure may be controlled as an input parameter for the design of the body 200. These input parameters may be relatively easily controlled in the design process using tools such as CAD. The input parameters may lead to variation in derived parameters, including, but not limited to, bulk density, void ratio, hardness, compressibility, and/or wettability. These derived parameters may be a result of a combination of multiple input parameters. The derived parameters may be relatively easily determined by measuring the weight and volume of the network 100 and the container. Accordingly, for a desired growth condition (e.g., including, but not limited to, fluid retention, pathogen resistance, drainage of nutrient solution from roots of plants, fluid percolation, and/or bulk density), the input parameters may be modified. The derived parameters of those input parameters may then be measured or calculated and used to alter the input parameters to achieve the optimal fluid retention value for a given plant organism.

Returning to fluid retention as an exemplary design parameter, an experiment was conducted to determine the impact that shape and size have on the fluid retention of a network 100 of bodies 200. Three shapes of bodies 200 were used: conical, cubic, and spherical. Three sizes of each shape were used: 4 mm, 7 mm, and 10 mm in diameter. The experiment found an inverse relationship between size and water retention, the larger the size of the body 200, the lesser weight of water was retained. This decrease in water retention is due to the increase in macropores formed by the larger bodies 200. The experiment also found that the different shapes impacted the confidence of the output measurement of water retention. The conical and cubic bodies 200 resulted in an inconsistent distribution of macropores, reducing the confidence of water retention measurements. The spherical bodies 200 had a more consistent macropore size and a higher confidence due to the regularity of the macropores within the network 100 formed by the spherical bodies 200. In other words, the conical and cubic shaped bodies had an inconsistent porosity between individual bodies 200 within the network 100. The spherical bodies 200 consistently exhibited generally uniform interporosity. Table 2 provides a summary of this experiment, with the measured value of water retained (g). The water retention value was calculated by measuring the dry weight, saturating the network 100 with water, draining the water for 1 minute, and measuring the weight after draining.

TABLE 2
Water Retained Measured Against Shape and Size

Size

| Shape | 4 mm | 7 mm | 10 mm | Confidence |
|---|---|---|---|---|
| Conical | 2.92 | 1.83 | 1.9 | 0.75 |
| Cubic | 1.96 | 0.81 | 0.85 | 0.82 |
| Spherical | 2.67 | 1.48 | 1.28 | 0.92 |

To compare the water retention of various shapes, another experiment was conducted using geometries with an increased number of faces and vertices to increase the relative packing and reduce interbody porosity of the network 100. In this experiment, the shapes were spheres, dodecahedrons, and icosahedrons. The results showed that the dodecahedral and icosahedral shapes had higher water retention as compared to the spherical bodies due to the higher packing efficiency reducing the size of the interpores in the network 100. Table 3 provides a summary of this experiment, with the measured value of water (g).

TABLE 3
Water Retained Measured Against Shape and Size

Size

| Shape | 4 mm | 7 mm | 10 mm | Confidence |
|---|---|---|---|---|
| Sphere | 2.67 | 1.48 | 1.28 | 0.92 |
| Dodecahedron | 2.96 | 1.94 | 1.79 | 0.89 |
| Icosahedron | 3.31 | 2.54 | 1.86 | 0.99 |

To compare the effect of porosity on fluid retention, an experiment was conducted by varying the number of pores and the size of the body 200. Three grades were chosen, each grade corresponding to the number of pores in the body 200. The results showed that increasing the internal porosity (e.g., increasing the grade) increased the fluid retention in the network 100. Table 4 provides a summary of this experiment, with the measured value of water (g).

TABLE 4
Water Retained Measured Against Pore Number and Size

| | Size | | |
|---|---|---|---|
| Grade | 4 mm | 7 mm | 10 mm |
| 0 | 2.67 | 1.48 | 1.28 |
| 1 | 2.81 | 2.07 | 1.67 |
| 2 | 3.64 | 3.36 | 2.7 |
| 3 | 4 | 3.51 | 3.1 |
| Confidence | 0.94 | 0.87 | 0.94 |

The material composition of the bodies 200 may also impact the relative fluid retention of the network 100. An experiment was conducted to compare black eSun PLA Plus filament—1.75 mm against HATCHBOX Wood PLA filament—1.75 mm. The eSun PLA is relatively smooth and more hydrophobic than the wood PLA, which is more hydrophilic due to chemical groups on its surface. The experiment showed that the wood PLA had higher water retention, likely due to the increase in microscopic imperfections and an increase in hydrophilicity.

Hardness and/or compressibility may impact the fluid retention of the network 100. An experiment was conducted comparing the effect of hardness on water retention. Three materials (sponge, rubber, and PLA) were chosen based on their Shore D hardness values (<<5, ˜5, and >5 respectively). The materials were immersed in water and an initial water retention value was measured. The materials were then subjected to a weight of 1.8 kg during the 1 minute draining period and the water retention was again measured. The results of the experiment showed that a less hard material (<<5, sponge) experienced compression that significantly reduced void space and the overall porosity of the system, leading to reduced water retention. Materials with Shore D hardness of about 5 or more (rubber and PLA) had relatively consistent water retention under load. The measurements indicated a slight increase in water retention under load for the harder materials. Water retention under load may be an important parameter to consider, since the weight of the plant organism will increase throughout its life cycle. For example, vine crops often increase greatly in weight, such as, including, but not limited to, cucumbers, tomatoes, and peppers.

The shape and structure of the bodies 200 may be rounded and smoothened spheres to ensure higher fluid percolation because smoothened surfaces present less frictional forces that keep water against the force of gravity. The bulk density of one or more bodies 200 in the network 100 may be chosen such that the bodies 200 sink and do not float when the nutrient solution is applied. Individual bodies 200 for crops such as basil, lettuce, and spinach may retain fluid at, for example, 5-40% w/w, and percolate fluid at, for example, 1-4 gallons/square feet/24 hr.

Once the bodies 200 are designed and modelled, additive manufacturing, such as fused deposition modeling, may be used to form the body 200 out of, for example, PLA. PLA may be used because it has factors such as high-tensile strength, biodegradability, recyclability, biocompatibility, hydrophobicity, and reactivity in aqueous solution. PLA is a reusable, biodegradable, and inert material which may improve the reusability of the substrate and may allow for optimized plant organism cultivation conditions.

The additive manufacturing process may be repeated to produce a plurality of bodies 200. For example, around 75-100 bodies 200 may be used to occupy the container 300. The container 300 may be sized to be approximately a 1.01 by 1.01 by 2 inch rectangular-prism shaped hydroculture netpot. The substrates may retain about 5% to about 40% w/w of fluid at a pressure in the range of about 0.01 kPa to about 150 kPa and may percolate fluid at a rate of 0.1-4 gallons/feet²/24 hr. Retaining fluid in this range of rates may ensure that the optimal germination and cultivation of crops in deep water culture systems such that the organism's root system reaches the pool of nutrient solution. Once the root system reaches the nutrient solution, an optimal fluid percolation rate of 5-40% w/w may ensure that there is sufficient root zone fluid drainage such that pathogen accumulation is prevented at the rootzone and base of the organism's stem during both cultivation and harvesting. In some embodiments, the substrates may retain water in the range of about 0.1 kPA to about 1000 kPa, optionally in the range of about 1 kPa to about 500 kPa, or optionally in the range of about 100 kPA to about 150 kPa.

Once the bodies 200 have been printed, based on an ideal design, the designer may repeat the process for bodies 200 having slightly or drastically varied properties. Accordingly, the manufacturing step may be repeated for several networks 100, each varying from the other in porosity, water retention, and/or other parameters. The experiment may then be run using the same type of seed for the plant organism to be grown such that the experiment will test the ability of the network variations to successfully germinate and support that particular plant to harvest.

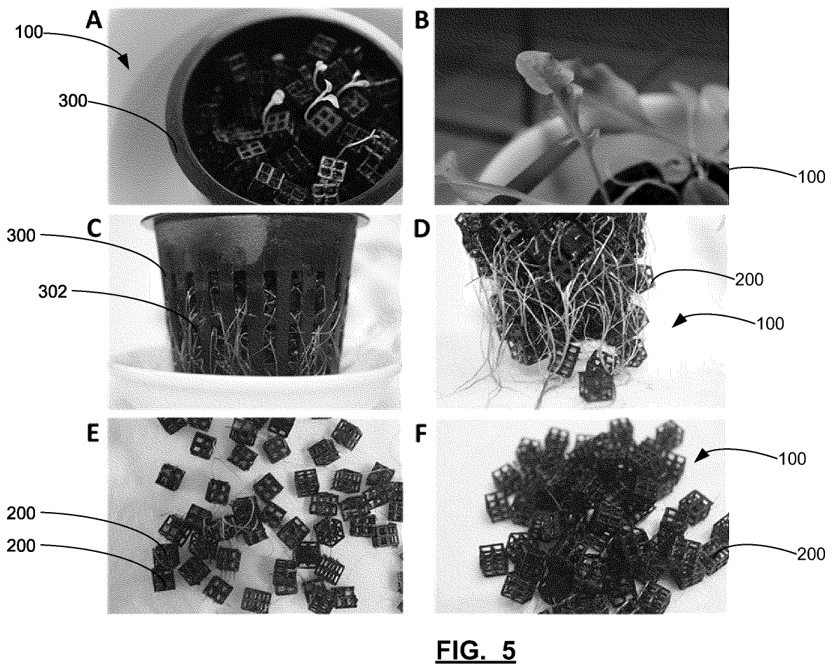

The container 300 may then filled with the 3D-printed bodies 200 to form a loose, porous network 100. As shown in FIG. 5C, the container 300 has holes 302 in the walls, which may allow water and/or nutrient solution to enter and exit the network 100 and may allow roots growing from the plant to exit the container 300. One or more seeds may be placed in the network 100 manually by hand or automatically by a machine at a desired depth in the network 100.

Nutrient-dosed water (i.e., nutrient solution) and/or gel may then be applied to each network 100 such that the seed is able to soak in the nutrient solution. The application of nutrient solution may vary depending on the water requirements for each plant. This application of nutrient solution can be done through several growing techniques, including, but not limited to ebb-and-flow, deep-water-culture, Kratky method, drip irrigation, nutrient film, and/or other common growing techniques.

This step may be repeated such that the network 100, gel, and/or seed(s) are repeatedly exposed to the nutrient-dosed water at regular intervals (or constantly), thus allowing the seed to germinate and grow until the plant is ready for harvest. The specific regime for applying the nutrient-dosed water will depend on the growing technique for each plant organism.

The plant may then be harvested. Once harvested, the weight of the plants (or another metric such as chlorophyll content, microbial content in the rhizosphere, taste of the plants, etc.) grown from each network 100 may be measured to determine which body 200 and/or combination of bodies in the network 100 achieved the most optimal outcome for that particular plant. The growth condition profile of this network 100 may then be identified as being the most suitable for that particular plant organism.

This optimal growth condition determination experiment may be repeated for any number of plant organisms. Once the growth conditions have been determined for each plant organism, one or more kits made of a plurality of individual bodies 200 may be formed. Each kit may have a plurality of similar or dissimilar bodies 200, such that the bodies 200 may be selected to form a network 100 having the ability to cater to a range of growth conditions. The kits may also be selected based on theoretical growth conditions, or by a combination of theoretical and empirical growth conditions.

In other words, to facilitate the ease of use of the substrate 100 by a user to grow a particular plant organism, several bodies 200 may be combined to form a kit made up of a plurality of multiple types of bodies 200. For example, a kit may be formed of a plurality of each body 200 shown in FIGS. 3A-3H. The kit may come with a set of instructions that explain the water demand for each type of plant that may be grown, so that the user can use the kit to grow any number of different plants by selecting the proper ratio of bodies 200 from the kit. For example, if a user is attempting to grow basil, a plurality of bodies 200 may be selected such that the network porosity is in the range of about 86-95% porosity. The specific ratio of types of bodies 200 may be outlined in the instructions such that the user knows the ratio of bodies 200 that should be used to form the network 100 to optimally grow basil with the defined growth condition. In other words, a ratio of bodies 200 of a first type and bodies 200 of a second type are combinable in a ratio such that the combination of bodies 200 forms the network having one or more desired growth conditions. It will be appreciated that different ratios may apply depending on the types of bodies 200. For example, if there are three types of bodies, the ratio may encompass all three types to form the network 100 having one or more desired growth conditions. Any number of types of bodies 200 may be used to form the network 100.

The kit may include one or more additives for modifying the growth of one or more plant organisms. For example, the kit may include a treatment or coating that modifies the surface of at least one body in the plurality of first bodies or the plurality of second bodies. An example coating is a gel. The gel may be used to facilitate the fluid and/or nutrient retention of a plant organism during part or all of its life cycle, as described previously.

### Method of Optimizing Plant Growth

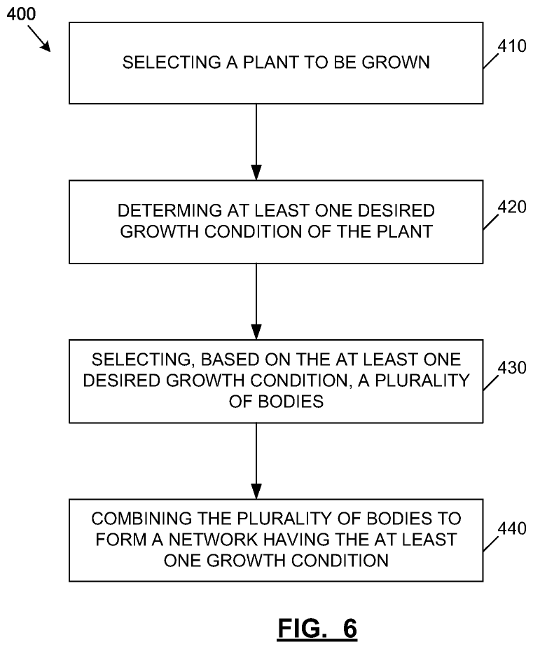

Referring to FIG. 6, a flow chart is shown outlining the steps for creating the network 100. The user may use the network 100 to cultivate a specific plant organism in a hydroculture environment. The user may refer to commercial hydroculture companies and/or hobbyist hydroculture users.

At step 410, the user may begin by selecting a plant organism to be grown. At step 420, the user may then select one or more desirable growth conditions for the selected plant. For example, selectable growth conditions may include, but are not limited to, the water-to-air ratio, pathogen resistance, fluid retention, drainage of nutrient solution from roots of plant, porosity, structure, fluid percolation, bulk density, capillary action, texture, field capacity, matric potential, gravitational potential, gas diffusivity, preferential flow, and/or submergence potential.

At step 430, a plurality of bodies 200 are selected based on the at least one desired growth condition. At step 440, the plurality of bodies 200 are combined to form the network 100 such that the network 100 has the at least one desired growth condition. The user may then pour the mixture of individual bodies into a containment apparatus 300 such as a hydroponic net cup to form the substrate 100 for receiving a plant organism.

In some embodiments, the plurality of bodies 200 may be a plurality of first bodies 200 and a plurality of second bodies 200 may be chosen to be combined with the plurality of first bodies 200 to form the network 100. The first bodies 200 and the second bodies 200 may have different design parameters such that the first bodies 200 and the second bodies 200 are combinable to form the at least one growth condition.

Optionally, after step 420, the bodies 200 of the network 100 may be designed to meet the at least one desirable growth condition selected at step 410. As described previously, design software may be used to design the bodies 200 and additive manufacturing may be used to manufacture the bodies 200. This optional step also applies for designing the first and second bodies 200. In other words, once the desired growth condition is selected, the bodies 200 may be customized for that particular growth condition and manufactured accordingly.

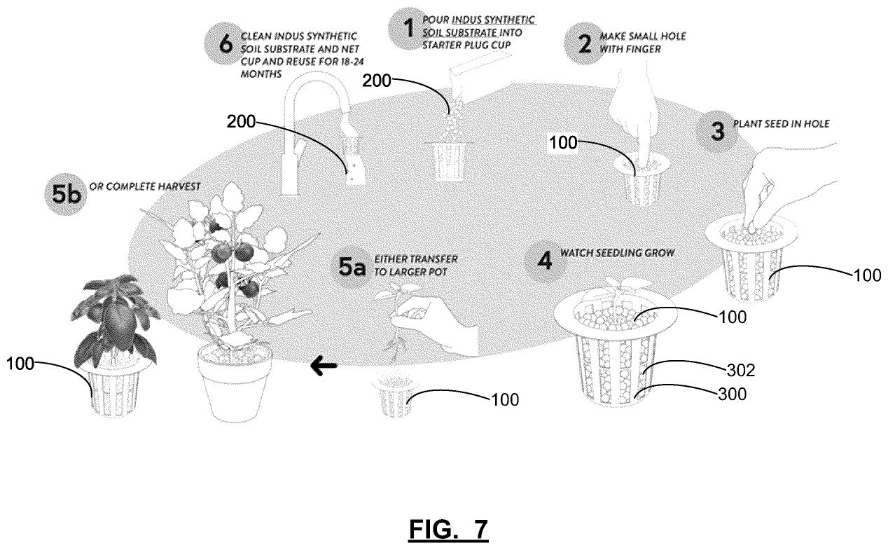

Once the network 100 has been formed, based on the at least one desired growth condition, the user may then begin the growth process. An illustration of the growth process is shown in FIG. 7. The user may create a small indent with their finger or an apparatus to form a void area for the plant organism(s) (e.g., seeds) to be placed.

The plant organism(s) may then be cultivated using a preferred hydroculture method including, but not limited to ebb-and-flow, deep-water-culture, Kratky method, drip irrigation, nutrient film, and/or other common growing techniques. The plant organism may be grown by adding nutrient solution, water, and/or gel to the substrate 100, which may be held in the pores for the plant organism to access. Once the plant organism reaches a certain stage of its life cycle, for example, a seedling or adult organism, the plant organism may be transferred to a larger containment apparatus or cultivated within the same containment apparatus to allow the plant organism to reach full maturity.

Once the plant organism reaches full maturity, plant organism may be harvested. The plurality of bodies 200 may resemble loose particles of soil, which may be conducive to extracting the rooted plant organisms with less labour-intensive means. Easier extraction of the root structure from the plurality of bodies 200 may improve the reusability of the network 100 by reducing structural degradation caused by separating the roots from the bodies 200. For example, the extraction may be conducted by pulling individual bodies 200 off of the roots by hand or using specialized scraping tools.

The individual bodies 200 in the network 100 may then be cleaned and/or sterilized using solvents including, but not limited to, water, boiling water, ozone gas, 20-70% acetic acid, 70% ethanol, 30% KOH, 0.01%-5% sodium hypochlorite, and/or H2O2 vapour. The bodies 200 may also be cleaned by application of heat. The cleaned bodies 200 may then be reused for the growing cycle of the same plant organism or for a second plant organism. This less labour-intensive cleaning procedure that occurs post-harvest may avoid the need for energy-intensive and labor-intensive waste removal/management and recycling protocols, thereby enabling the reusability of the substrate 100. It will be appreciated that the substrates 100 may be reused until significant structural deformities in their physical composition appears. For example, substrates manufactured out of PLA may last about 18-24 months because the PLA may begin to show structural deformities after this period of use.

### Example Growth of a Plant Organism

Referring to FIGS. 5A-5F, shown therein is an example growth of a plant organism. As shown, the plant organism is lettuce. FIG. 5A shows freshly printed (through additive manufacturing) bodies 200 that are placed in the netcup 300 and seeded with lettuce seeds. The seeds were watered twice a day by flushing the network 100 with tap water. Once the seeds germinated, as shown in FIG. 5A, the Kratky-method was used (similar to commercial deep-water culture hydroponic growth).

As shown in FIG. 5B, larger leaves formed approximately two to three weeks into the growth cycle. Once the growth cycle was complete, as shown in FIGS. 5C-5D, the roots of the lettuce were formed through the intra-body pores 220 and the inter-body pores 120, as well as through the holes 302 in the netcup 300. These pores and holes provide support for the roots of the lettuce.

Once the lettuce was harvested, some roots remained in the network 100, as shown in FIG. 5E. The remaining roots were removed by shaking the bodies 200 in a strainer with holes large enough for the roots to be removed, but small enough that the bodies 200 could not pass through. Finally, as shown in FIG. 5F, the bodies 200 were pressure washed and soaked in dilute bleach to sterilize the material. The bodies 200 may then be used for another growing cycle.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A growing medium for a plant organism comprising:
a plurality of bodies forming a network of bodies, each body in the plurality of bodies having a Shore D hardness value of at least 5,
wherein at least one body in the plurality of bodies has at least one pore for receiving a fluid.

2. The growing medium of claim 1, wherein the at least one pore extends from a first side of the at least one body to a second side of the at least one body such that liquid is passable from the first side to the second side, and/or wherein the at least one pore is a recess in a first side of the at least one body, and/or wherein the network of bodies has a network porosity in the range of about 20% to about 95%.

3-4. (canceled)

5. The growing medium of claim 1, wherein the plurality of bodies comprises a plurality of first bodies and a plurality of second bodies, wherein the plurality of first bodies and the plurality of second bodies are combinable to form the network of bodies, optionally i) wherein the plurality of first bodies and the plurality of second bodies are combinable in a ratio such that the combination of the first bodies and the second bodies at the ratio forms the network having the at least one desired growth condition, and/or ii) wherein a selectable parameter of each body in the plurality of first bodies is different from the corresponding selectable parameter of each body in the plurality of second bodies and the selectable parameter is at least one of structure, size, shape, material composition, void ratio, porosity, pore size, pore position, number of pores, hardness, compressibility, rigidity, bulk density, fluid retention, fluid percolation, pathogen resistance, permeability, surface chemistry, material bulk properties, or wettability.

6-7. (canceled)

8. The growing medium of claim 1, wherein one or more bodies in the plurality of bodies is modified to alter a surface property of the one or more bodies.

9. The growing medium of claim 8, wherein the surface property modification comprises at least one of amino acids, polypeptides, sugars, collagen, organic molecules, alkali earth metals, transition metals, polyatomics, or alkanes.

10. (canceled)

11. The growing medium of claim 8, wherein the surface property modification is at least one of a surface air plasma treatment or alkali treatment.

12. The growing medium of claim 1, wherein the plurality of bodies is formed by at least one of additive manufacturing and injection molding.

13. The growing medium of claim 1, wherein the at least one pore is at least one of a macro intra-body pore and a micro intra-body pore, and/or wherein the network of bodies has a plurality of inter-body pores, and/or wherein at least one body in the plurality of bodies has a polyhedral shape and/or is round.

14-16. (canceled)

17. The growing medium of claim 1, wherein each body in the plurality of bodies has a melting temperature of at least 100° C., optionally each body in the plurality of bodies comprises at least one of a biodegradable material or a recyclable material, optionally the biodegradable material is at least one of thermoplastic starch-based plastic (TPS), polyhydroxyalkanoates (PHA), polylactic acid (PLA), polybutylene succinate (PBS), or polycaprolactone (PCL).

18-19. (canceled)

20. A method of optimizing growth of a plant organism, the method comprising:
selecting a plant organism to be grown;
determining at least one desired growth condition of the plant organism;
selecting, based on the at least one desired growth condition, a plurality of bodies; and
combining the plurality of bodies to form a network for growing the plant organism, the network having the at least one desired growth condition.

21. The method of claim 20, wherein i) at least one body in the plurality of bodies has at least one pore, and/or ii) the plurality of bodies is a plurality of first bodies, and the method further comprises selecting, based on the at least one desired growth condition, a plurality of second bodies, optionally further comprising combining the plurality of first bodies and plurality of second bodies together to form the network for receiving the plant organism, optionally the first bodies and the second bodies are selected based on a ratio of first bodies to second bodies such that the combination of first bodies and second bodies at the ratio forms the network having the at least one growth condition.

22-24. (canceled)

25. The method of claim 20, wherein the at least one desired growth condition includes water-to-air ratio, pathogen resistance, fluid retention, drainage of nutrient solution from roots of plant, porosity, structure, fluid percolation, bulk density, capillary action, texture, field capacity, matric potential, gravitational potential, osmotic potential, water capillarity, gas diffusivity, preferential flow, or submergence potential.

26. The method of claim 20, further comprising i) determining a plurality of desired growth conditions and selecting, based on the plurality of growth conditions, a plurality of bodies, or ii) inserting the plant organism to be grown into the network of bodies; adding at least one of a nutrient solution, gel, or water to the network of bodies; and harvesting the plant from the network of bodies at the completion of the first growth cycle, optionally further comprising cleaning the network of bodies for reuse in at least a second growth cycle for the plant organism or for a second plant organism, optionally cleaning the network of bodies includes achieving a sterility assurance level of less than 10-2.

27-29. (canceled)

30. The method of claim 20, further comprising, after determining the at least one desired growth condition:
designing the body having at least one parameter to achieve the desired growth condition, and
manufacturing a plurality of the bodies;
optionally the plurality of bodies is manufactured by at least one of additive manufacturing and injection molding, and/or further comprising treating or coating at least one body in the plurality of bodies to modify a surface property of the body.

31-32. (canceled)

33. The method of claim 20, further comprising after determining the at least one desired growth condition:
designing the second body having at least one parameter to achieve the desired growth condition, and
manufacturing a plurality of the second bodies;
optionally the plurality of second bodies is manufactured by at least one of additive manufacturing and injection molding, and/or further comprising treating or coating at least one second body in the plurality of second bodies to modify a surface property of the second body.

34-35. (canceled)

36. The method of claim 20, wherein the network of bodies has a network porosity in the range of about 20% to about 95%, and/or wherein each body in the plurality of bodies has a Shore D hardness of at least 5.

37. (canceled)

38. A kit for plant organism growth having at least one desired growth condition, the kit comprising:
a plurality of first bodies, at least one first body in the plurality of first bodies having at least one pore and each first body in the plurality of first bodies having a first parameter; and
a plurality of second bodies, at least one second body in the plurality of second bodies having at least one pore and each second body in the plurality of second bodies having a second parameter,
wherein the first parameter and the second parameter are at least one of structure, size, shape, material composition, void ratio, porosity, pore size, pore position, number of pores, hardness, compressibility, rigidity, fluid retention, fluid percolation, pathogen resistance, permeability, surface chemistry, material bulk properties, wettability, or bulk density,
the first parameter is different than the second parameter, and
a selection of the plurality of first bodies and a selection of the plurality of second bodies are combinable to form a network of bodies such that the network forms the at least one desired growth condition based on the first parameter and the second parameter.

39. The kit of claim 38, further comprising a plurality of third bodies, the third bodies being different than the plurality of first bodies and the plurality of second bodies, optionally further comprising a plurality of fourth bodies, the fourth bodies being different than the plurality of first bodies, the plurality of second bodies, and the plurality of third bodies, optionally further comprising a plurality of fifth bodies, the fifth bodies being different than the plurality of first bodies, the plurality of second bodies, the plurality of third bodies, and the plurality of fourth bodies.

40-41. (canceled)

42. The kit of claim 38, wherein each body in the plurality of first bodies and the plurality of second bodies has a Shore D hardness value of at least 5, optionally further comprising i) at least one of a nutrient solution, water, or gel, and/or ii) at least one plant organism seed; and/or iii) instructions specifying a ratio of first bodies and second bodies such that the combination of the first bodies and the second bodies at the ratio forms the network having at least one desired growth condition.

43-45. (canceled)

46. The kit of claim 38, further comprising an additive that modifies the surface of at least one body in the plurality of first bodies or the plurality of second bodies, optionally the additive is at least one of a gel or surface modifier.

47. (canceled)
